(19) United States
(12) Patent Application Publication
(10) Pub. No.: US 2025/0242378 A1
(43) Pub. Date: Jul. 31, 2025

(54) DEVICE FOR THE DEPOSITION OF DECORATIVE SCATTERING MATERIALS ONTO AN OBJECT, WITH OSCILLATION

(71) Applicant: Signature Brands, LLC, Ocala, FL (US)

(72) Inventors: Sean MORAN, Corvallis, OR (US); Thomas THIEMANN, Orlando, FL (US); Charles HODGES, Clemmons, NC (US); Joshua GORDON, Ocala, FL (US)

(21) Appl. No.: 18/428,932

(22) Filed: Jan. 31, 2024

(51) Int. Cl. B05C 19/00

(52) U.S. Cl. CPC B05C 19/00

(57) ABSTRACT

A device for deposition of decorative scattering materials on an object includes a base and a cover that may be releasably coupled to the base to form a volumetric enclosure. The base includes a top surface having an object support for receiving the object. The decorative scattering materials are received on the top surface. A power switch activates air flow through the volumetric enclosure. A nozzle may be manipulated by a user to change the flow air around the volumetric enclosure to control the deposition of decorative scattering materials.

### BACKGROUND OF THE INVENTION

### 1. Field of the Invention

The disclosed embodiments relate to the decoration of objects, such as Easter eggs. More particularly, the disclosed embodiments are directed to a device having an oscillating feature for scattering decorative material onto an object for holiday decoration.

### 2. Discussion of Related Art

Holiday decoration is a popular tradition throughout the world. For example, the Easter holiday holds well-established traditions for the decoration of Easter eggs, and the art of decorating eggs and similar objects has been practiced for centuries. These eggs are traditionally comprised of chicken eggs, but can also include eggs made from synthetic materials such as plastic and foam. Typical materials and methods for decorating Easter eggs are highly manual in nature. Significant time and effort are required to decorate an Easter egg, and nearly every current material and method for decorating Easter eggs time-consuming clean-up and even irreversible damage to clothing and other surfaces. These existing techniques include stickers, painting, food coloring, and using other decoration materials. The decoration process often results in messes due to the distribution of the decoration materials throughout the decorating location (e.g., clothing, hands, working surfaces, etc.), thus requiring time-consuming cleanup.

A need therefore exists for an improved device and method of decorating Easter eggs and similar objects.

### SUMMARY OF THE INVENTION

The present invention is related to a device for decorating articles, such as eggs, nuts, candies and similar objects of the type commonly used as gifts and decorations on holidays, such as, by way of non-limiting example, Easter, Thanksgiving, and Christmas. The present invention and method solve the problems discussed previously by providing for the automatic deposition of scattering decoration materials in a contained environment while providing an entertaining experience by allowing participants to view and control the deposition process. A purpose of the present invention is to provide a simple and inexpensive apparatus and also an entertaining method of decorating objects, such as Easter eggs.

In accordance with one aspect of the present invention, a device and method for deposition of scattering decorative material, such as glitter or confetti, onto an object (real egg, synthetic egg or other substrate) is described here. The device includes a base having a top surface for receiving the scattering material and an air circulator enclosed in the base. An object support is positioned on the top surface of the base for receiving the object to be decorated. A cover is releasably coupled to the base to create a volumetric enclosure with the base when coupled thereto. A nozzle directs air generated by the air circulator within the volumetric enclosure to impart motion to the material and a nozzle control mechanism on the base allows a user to move the nozzle to direct air at different locations within the volumetric enclosure to impart motion to the scattering control how the material so that the material is deposited on the object.

The methodology for use of the device includes preparation of the object to be decorated with desired decorating processes and materials. The user may choose to add adhesive to the object surface to encourage more densely deposited materials onto the object. The adhesive may be a common adhesive or proprietary food-grade adhesives. The user places the desired scattering materials, such as confetti, glitter, or other materials, inside of the device, prior to, or after, placing the object on the object support, then connecting the container to the housing. The user then operates the device by activating a power switch, which energizes the electrical connection between the power source and the air circulator. The air circulator may circulate ambient air or, in one embodiment, heated air which may provide an adhesive property to the scattering material. The device dynamically suspends the scattering decoration materials throughout the volume inside the device. Random dynamic interactions between the suspended decoration materials and the object automatically deposit the decoration materials onto the object. The nozzle may be manipulated to influence the movement of the materials inside the cover. Also, the object support may be rotated by the user or automatically. Once the user is satisfied with the results of the automatic decoration, the power switch is de-energized such that the decoration materials are no longer suspended, and the container is detached from the housing. The user may choose to remove the decorated object from the device if preferred, or the user may choose to leave decorated object in the device or continue decorating the object through sequential operations of the device methodology to compound decoration materials.

### BRIEF DESCRIPTION OF THE DRAWINGS

Other objects and features of the present invention will become apparent from the following detailed description considered in conjunction with the accompanying drawings. It is to be understood, however, that the drawings are designed solely for purposes of illustration and not as a definition of the limits of the invention, which is defined by the claims appended hereto. It should be further understood that the drawings are not necessarily drawn to scale and that, unless otherwise indicated, they are merely intended to conceptually illustrate the structures and procedures described herein. In the drawings:

FIG. 1 is a perspective view of a device for decorating an object, in embodiments.

FIG. 2 is a perspective view of the device of FIG. 1 during operation, illustrating the turbulent air dynamically suspending decoration materials, which are then randomly deposited onto the object being decorated.

FIG. 3 is a flowchart illustrating a method for deposition of granular material on an object.

### DETAILED DESCRIPTION OF THE PRESENTLY PREFERRED EMBODIMENTS

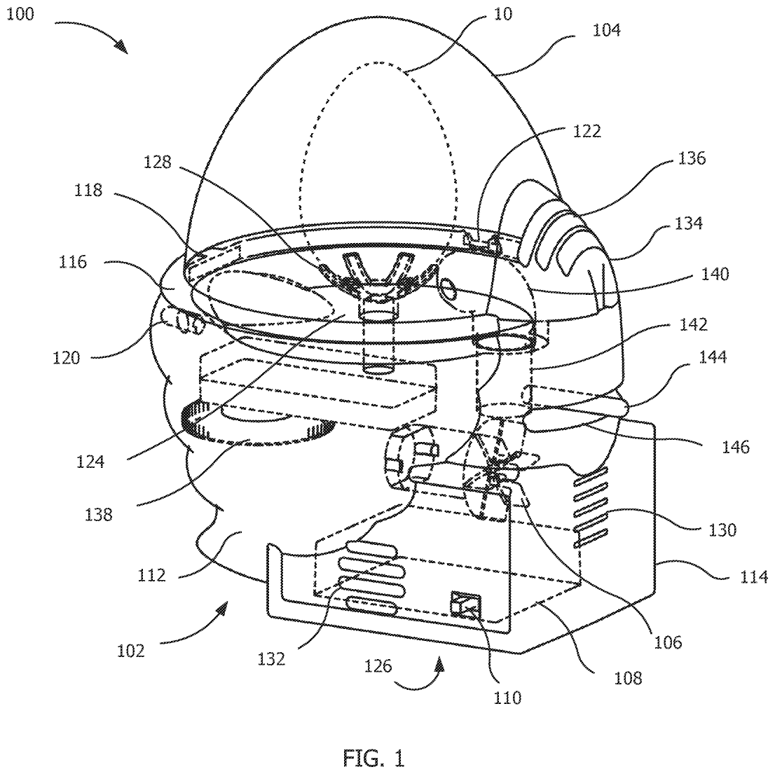

FIG. 1 is a perspective view of a material deposition device showing the components thereof as well as an egg or egg-shaped object to be decorated. It will be recognized that in most cases, the object to be decorated will be an egg-shaped decorative item, such as an Easter egg, however the invention is not limited to such an embodiment and, for example, the object to be decorated may be in other shapes instead of egg-shaped, in which case, a holder of the object will be so-configured.

As will be discussed in detail below, the disclosed material deposition device permits a user to decorate objects, such as Easter eggs, in a visually-entertaining way which allows the viewer(s) to observe the decorating process. The device will create attractive and unique decorations on the object to increase its aesthetic appearance, and also provide a simple solution for clean-up and storage after the decorating process.

In embodiments, the material deposition device 100 of FIG. 1 is used for deposition of granular material on an object 10. Device 100 has a base 102 and a cover 104, which include various elements, aspects, and functionalities of the device 100. Cover 104 is preferably formed of a transparent plastic material and is releasably attached to base 102 to form a volumetric enclosure around object 10. In some embodiments, the base 102 encloses various components the provide the material deposition functions of device 100, such as an air circulator 106 and a power source 108. In such embodiments, the base 102 may further include a power switch 110.

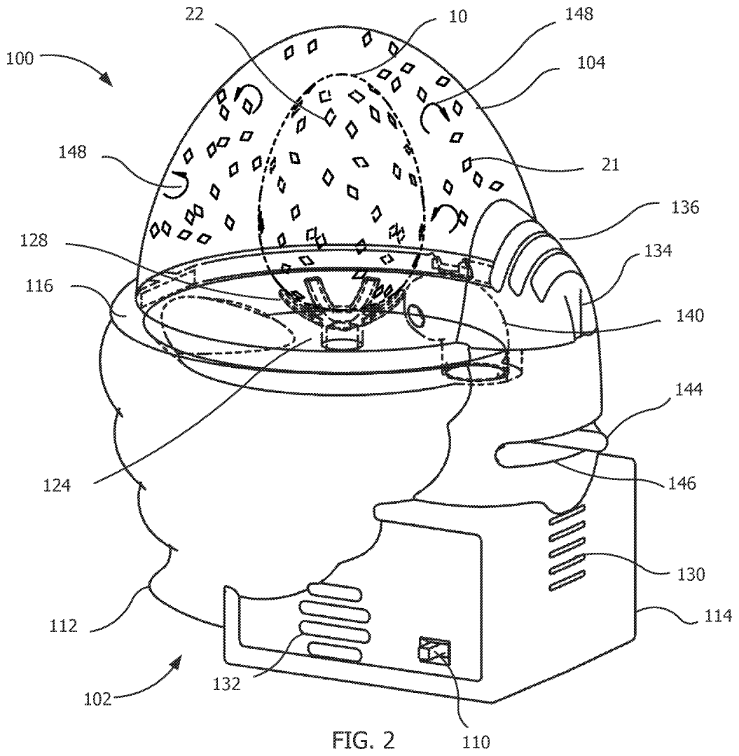

Any suitable design for the base 102 for supporting the cover 104 and object 10 can be used, as long as its shape and dimensions allow the operation disclosed herein. In some embodiments, the base 102 may be made from rigid materials, such as hard plastic or stainless steel, to provide sufficient rigidity to maintain an overall shape for support. In some embodiments, the base 102 can also include more user friendly features. For example, the base 102 may include one or more access doors (not shown). As shown in FIG. 1, base 102 includes a first portion 112 that has a generally circular or oval cross-section. An upper rim of first portion 112 engages with cover 104, as described below. A second portion 114 of base 102 is more rectangular and attached to one side of the first portion 112. A representative embodiment of base 102 and cover 104 will be discussed with reference to FIGS. 1 and 2, but variations may be made without departing from the principles disclosed herein. For example, base 102 may be entirely rectangular with upper rim 116 on an upper surface for engaging with cover 104.

In some embodiments, the cover 104 is releasably connectable to the base 102 in a manner to seal the inner volume of the device 100. In various embodiments, the morphology of the cover 104 may be designed such that the material deposition process of the object 10 meets the requirements stated herein, including the optimization of functions disclosed herein to ensure random interactions of dynamically suspended granular materials onto the object 10. In various embodiments, the cover 104 may be dome-shaped and fabricated from normal industrial materials used in the field, such as glass, clear plastic (e.g., polycarbonate, acrylic, etc.), or other readily available materials as long as the selected material is visibly clear. Preferably, cover 104 is formed of a plastic material that is less susceptible to breaking or cracking, as compared to glass. It should be also understood that although the cover 104 is shown having an oval or egg shaped configuration such that its walls are substantially, continuously curved to provide efficient air circulation and, hence, circulation of the decoration materials, other shapes, of course, will be known to those of ordinary skill in the art.

In some embodiments, cover 104 may connect to the base 102 via a cover latch 118, which is actuated by cover release lever 120. In such embodiments, object 10 may be put in place within the device 100 when the cover 104 is detached from the base 102, and then the cover 104 may be placed over the object 10 and aligned with upper rim 116. Cover latch 118 may be spring loaded to enable cover 104 to snap in place. Cover release lever 120 may be actuated to engage and/or release cover latch 118. When the decoration process is complete, the cover 104 is again disengaged by manipulating release over latch 118 or by turning (e.g., counter-clockwise) to allow the object 10 to be removed from object support 128 if preferred by the user.

In some other embodiments, the cover 104 may connect to first portion 112 of base 102 using an interface locking mechanism (e.g., a snap-fit mechanism), that accommodates the bottom geometry of the cover 104. In any embodiment, cover 104 is temporarily and securely held in place to base 102 during the materials deposition process so that, during air circulation, detachment is prevented. Cover safety switch 122 may be included in upper rim 116 to detect a detachment of cover 104 from base 102 and automatically stop operation of device 100, for example, by stopping air circulator 106.

Upper rim 116 of base 102 encloses a top surface on which the scattering material may be disposed prior to a deposition process. In embodiments, top surface is preferably sloped downward from its outer boundary toward its center. In embodiments, the top surface 124 may be sloped towards a center point and may include also a recessed area for receiving the material. Both first portion 112 and second portion 114 of base 102 have a common bottom surface 126 so that device 100 may rest securely on a table of other flat surface.

Second portion 114 is depicted as being located on one side of first portion 112. Other positions of second portion 114 are possible. Second portion 114 is shown as including several features, although some or all of these features may also be located on first portion 112. These features include power switch 110 and one or more air intake openings 130, e.g. vents. Additional features to facilitate air flow 132 may be provided.

Base extension 134 extends upward from first portion 112 along cover 104. An interior of base extension 134 is open to the volumetric enclosure of cover 104. To facilitate air flow throughout the volumetric enclosure around object 10, one or more exhaust openings 136 may be provided in base extension 134. In embodiments, the exhaust 134 may take the form of a set of holes or slots that allow air to escape from cover 104 during operation of air circulator 106. Other locations for an exhaust passage are within the scope of the present disclosure. In embodiments, a filter may be incorporated in communication with the exhaust opening to prevent scattering materials from exiting the volumetric enclosure.

As shown here, object support 128 is positioned on top surface 124 of base 102. In embodiments, object support 128 is generally in the center of top surface 124, but other arrangements are possible. Object support 128 is configured to hold an object to be decorated. In the case of an egg or egg-shaped object 10, support 128 is contoured or otherwise shaped to receive a bottom of the egg in a stable manner. Object support 128 may be fixed in place. In various embodiments, object support 128 may be mounted for rotation with respect to the top surface 124, such as by automatic rotation via use of a motor or by manual rotation with the use of an object control mechanism such as manual object rotation control 138. As shown in FIG. 1, manual object rotation control 138 is a knurled wheel that may be manipulated by a user to cause object support 128 to rotate and, thus, rotate object 10 to vary the deposition of scattering material on object 10. In embodiments, other mechanisms for rotating object support may be provided, including the manual mechanism of twisting a knob or moving a lever, or an automatic rotation when air circulator 200 is switched on, for example.

In various embodiments, the object support 128 conforms to the geometries of the object 10 to provide appropriate structural bearing support and restraint force for the object 10 while, preferably, exposing a maximum of surface area of the object to be decorated. It should be understood that the object support 128 may be of a fixed dimension or may be adjustable for better supporting the object to be decorated and accommodating different object sizes. For example, in some embodiments, the object support 128 may include an adjustable opening that can be sized by a user, e.g., by manipulating a thumb screw or the like, to accommodate objects of varying sizes and shapes.

A directable air flow nozzle 140 extends upward from top surface 124 then curves to direct air flow from air circulator 106 towards top surface 124 and the materials disposed thereon. Nozzle 140 and air circulator 106 may be connected by passage 142. Nozzle 140 may be oscillated from side to side by manually using air flow direction control mechanism such as lever 144 which may be moved horizontally from side to side in slot 146. The range of movement of nozzle 140 may be any amount within the limits of cover 104. The use of nozzle 140 with a manual control mechanism allows a user of the device to have control over the direction of the airflow from nozzle 140 to selectively impart motion to the scattering material within cover 104, which provides increased distribution and an entertaining experience. In embodiments, other mechanisms for rotating object support may be provided, including twisting a knob.

Although manipulation of air flow is shown by user activatable lever 144 positioned for back-and-forth (x-y) movement within slot 146, such movement could additionally be provided in an up/down (z) direction, such as by widening slot 146, using a joystick instead of lever 144, or other modifications which are readily known by those with ordinary skill in the art. It should be appreciated that user control of air flow direction will provide user participation, enhanced entertainment value, affect the flow of the deposit material and hence, the final decoration of object 10.

Air circulator 106 is powered by the power source 108, which provides sufficient energy to generate turbulent air flow conditions (e.g., appropriate air flow rates and pressures) capable of dynamically suspending decoration materials 20 inside the device 100. The use of a transparent material for cover 104 enables the user to observe the entire materials deposition process, while also controlling the materials deposition process.

FIG. 2 is a perspective view of the device of FIG. 1 during operation, illustrating the turbulent air dynamically suspending decoration materials, which are then randomly deposited onto the object being decorated to result in a decorated object 11. The turbulent air is transferred from air circulator 106 in base 102 to scattering materials 20 through the use of nozzle 140, and then exits through exhaust opening 136.

In some embodiments, the scattering materials 20 used for decorating are well known and readily available commercially, such as confetti, glitter, or other decoration materials, preferably those approved by the Food and Drug Administration (FDA) and conventionally used to decorate eggs in different colors, including red, yellow, blue, brown, orange, green, pink, chartreuse, or combinations of the above.

In various embodiments, the power source 108 may include standard batteries, a power supply powered by external energy, such as 120 volt power, or standard universal serial bus power from a standard connection on a computer/laptop or other similar devices. It should be understood that the specifications of the power source 108 should be matched to the power requirement of the air circulator 106 to function properly. In some embodiments, the air circulator 106 is operable only when the base 102 is connected to the cover 104 as detected by cover safety switch 122. This prevents the accidental operation of the device 100, for example, by children. In some other embodiments, the air circulator 106 is capable of operating at multiple speeds, for example, via a variable-frequency drive (VFD).

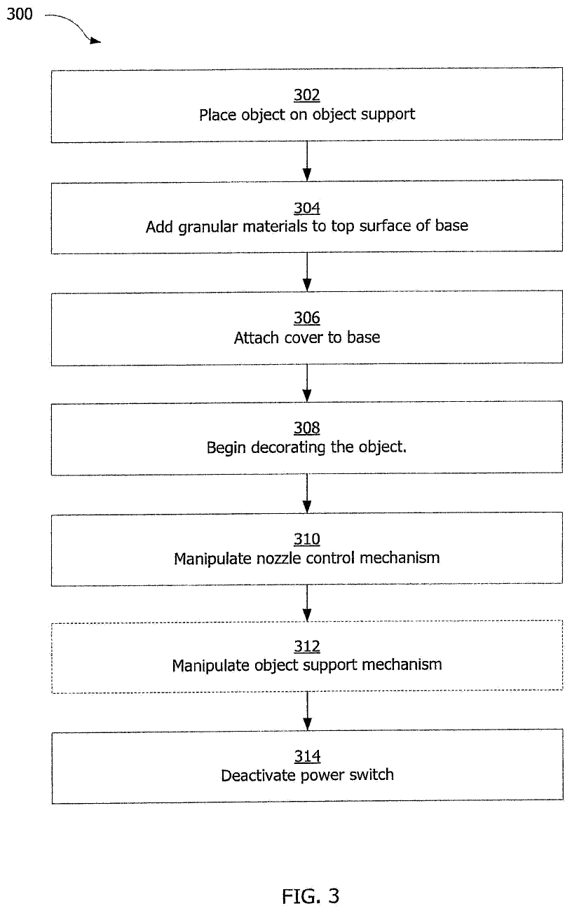

FIG. 3 is a flowchart illustrating a method for deposition of scattering material on an object. The method includes steps 302, 304, 306, 308, 310 and 314. In embodiments, the method also includes step 312.

In step 302, the user places an object 10 to be decorated on object support 128. In an example of step 302, object support 128 may be adjusted to better support object 10 by changing its size of shape.

In step 304, scattering materials 20 for use in decorating object 10 are added to the top surface 124 of base 102. In some embodiments, top surface 124 may be angled or sloped downward from an outer periphery toward object support 128 at a center of top surface 124. The user may plan how they would like to decorate the object 10. The object 10 may be decorated by any process subject of current state of the art in the industry prior to further decorating as described, or plain, undecorated objects 10 may be used as well. State of the art decorating may include dying with food coloring, painting, marking with pens or markers, or even with the application of adhesives may be applied if desired. Unlimited decoration possibilities are possible in the object decoration process, and these processes can be incorporated with the materials deposition process disclosed herein.

In step 306, cover 104 is secured to base 102. In an example of step 306, cover 104 may be attached to base 100 through a latch and/or a snap fit attachment.

In step 308, the user starts the decoration process of object 10. In an example of step 308, the user starts by activating power switch 110 to begin circulation of the decoration materials 20 within the volumetric enclosure. The switch may accommodate multiple air circulation speeds such as by operating air circulator 106, such as a fan, which in turn may yield different decorating results.

In step 310, the user manipulates the airflow direction control mechanism 144. In an example of step 310, a user moves lever 144 in slot 146 to cause nozzle 140 to pivot back-and-forth across top surface 124. In embodiments, a knob may be used with a twisting movement. FIG. 2 illustrates the materials deposition process during operation, wherein the decoration materials 20 becomes dynamically suspended through turbulent air currents 148 generated by the device 100 as described herein. The materials deposition process continues as long as the device 100 is energized. The materials deposition process is possible through the creation of high occurrences of interactions between the dynamically suspended decoration materials 21 and the object 10, wherein some of the interactions result in deposited decoration materials 22 onto the object 10 to create a decorated object 11.

In optional step 312, a user may also manipulate object support 128. In an example of step 312, the user may move manual object rotation control 138 to cause rotation of object support 128. In embodiments, a twisting action of a knob may also be used.

In step 314, power switch 110 is deactivated. In an example of step 314, when the user is satisfied with the decoration quality of the decorated object 11, the user then de-energizes the device 100 through de-activation of the power switch 110 to stop the decoration process. The user may display the decorated object in the present state inside the device 100, which is enabled through the transparent nature of the cover 104. If preferred, the user may also disconnect the cover 104 from the base 102 and remove the decorated object from the device 100. The user may also place the decorated object back into the device 100 or allow the decorated object to remain on the support, and use newly selected scattering materials 20 to add additional decoration to the decorated object. Similarly, the user may also remove the remaining decoration materials 20 from the device 100 by removing the cover 104 from the base 102 and then turning the device 100 on its side. This is analogous to pouring the granular materials 20 out of any small container. The funnel shape of the top surface 124 encourages removal of the granular materials 20 from the device 100.

The transparent design of the cover 104 enables the user, and observers, of the device 100 to visually observe the automatic deposition of materials onto the object 10. This process is not only enjoyable for the user to observe as the artistic creation is being created, but also allows user participation by controlling air flow direction as well as the beginning and ending time of the materials deposition process through activation and deactivation of the power switch 110. An air speed control may also be provided in certain embodiments to control the force of air applied to the scattering materials. The air flow, in one embodiment, may be heated to activate an adhesive property of the scattering material to assist in adherence to the object to be decorated, e.g., the egg. In some embodiments, the materials deposition process may potentially be enhanced through the use of common adhesives, such as food grade sugar-based adhesives, or other adhesives applied directly to the object 10. Although this is not required for the function of the device 100, this is disclosed as a potential option for users to enjoy the use of the product depending upon the desired artistic results, or to enhance the level of material deposition of certain types of the decoration materials 20.

While there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice.

What is claimed is:

1. A device for decorating an object with a scattering decorative material, comprising:
a base having a top surface for receiving the material,
an air circulator enclosed in the base;
an object support on the top surface of the base, the object support supporting the object to be decorated;
a cover made of transparent or translucent material and releasably coupled to the base to create a volumetric enclosure with the base when coupled thereto;
a nozzle for directing air generated by the air circulator within the volumetric enclosure to impart motion to the decorative material within the volumetric enclosure; and
a nozzle control mechanism on the base for moving the nozzle to direct air at different locations within the volumetric enclosure.

2. The device according to claim 1, further comprising an exhaust passage for facilitating air flow throughout the volumetric enclosure.

3. The device according to claim 2, wherein the exhaust passage comprises a filter to restrict decorative materials from exiting the volumetric enclosure.

4. The device according to claim 2, wherein the exhaust passage is an opening in the cover.

5. The device according to claim 2, wherein the exhaust passage comprises a portion of the nozzle.

6. The device according to claim 1, wherein the top surface of the base is angled toward a center of the top surface.

7. The device according to claim 1, wherein the object support is in a center of the top surface and the top surface includes a recessed area for receiving the decorative material.

8. The device according to claim 1, wherein the object support is rotatable.

9. The device according to claim 8, wherein the object support is coupled to a rotation control mechanism on the base for manual rotation of the object.

10. The device according to claim 1, wherein the object support is adjustable to conform to a shape of the object.

11. The device according to claim 1, wherein the nozzle is pivotably coupled to the base.

12. The device according to claim 1, further comprising an interface locking mechanism between the base and the cover.

13. The device according to claim 14, wherein the interface locking mechanism is a snap-fit mechanism.

14. The device according to claim 2, wherein the air circulator is operable only when the base is connected to the cover.

15. The device according to claim 14, wherein the air circulator is capable of operating at multiple speeds.

16. The device according to claim 14, wherein the air circulator is capable of circulating heated air.

17. A method of decorating an object with scattering material using a device according to claim 1, comprising:
a) placing the object in the object support of the device;
b) adding the scattering material to the top surface of the base of the device;
c) coupling the cover with the base;
d) commencing circulation of the scattering material within the volumetric enclosure;
e) manipulating the nozzle control mechanism to direct air to different locations on the top surface; and
e) ceasing circulation of the scattering material.

18. The method of claim 16, further comprising manipulating a rotation control mechanism to rotate the object support.
